(19) United States
(12) Patent Application Publication
(10) Pub. No.: US 2011/0301862 A1
(43) Pub. Date: Dec. 8, 2011

(54) System for array-based DNA copy number and loss of heterozygosity analyses and reporting

(76) Inventor: Anton Petrov, London (GB)

(21) Appl. No.: 12/794,463

(22) Filed: Jun. 4, 2010

(51) Int. Cl. G06F 19/00

(52) U.S. Cl. 702/20

(57) ABSTRACT

The problem of analyzing, visualizing an interpreting data of DNA arrays (array CGH and SNP arrays) in a clinical setting becomes very important as DNA arrays take over clinical diagnostics. Reporting of detected chromosomal aberrations are complicated with data noise and presence of “normal” chromosomal variants that may occur even in healthy patients. Clinicians are facing interpretation of array data and detected chromosomal anomalies in patient samples every day. The disclosed system provides means for automated detection of chromosomal anomalies in individual samples. It also enables its users to interpret detected aberrations in an efficient manner so that clinically relevant anomalies get reported and aberrations that can occur in healthy patients get ignored. It also allows its users to accumulate and mine data from multiple human samples and re-use it in daily diagnostic operations to improve clinical interpretation of newly acquired samples.

### BACKGROUND OF THE INVENTION

The underlying progression of genetic events which transform a normal cell into a cancer cell is characterized by a transition from the diploid to anueploid state (Albertson et al. (2003), Nat Genet, Vol. 34, pp. 369-76 and Lengauer et al. (1998), Nature, Vol. 396, pp. 643-9). As a result of genomic instability, cancer cells may accumulate random and causal alterations at multiple levels from point mutations to whole-chromosome aberrations of two types: loss of heterozygosity (LOH) and copy number changes. Therefore such alterations can be used for diagnostics of different types of cancer. Various types of DNA copy number changes in human patients can also lead to high risk of a wide spectrum of other types of disorders such as, but not limited to developmental disorders, vision disorders, neurological disorders and cardio vascular disorders.

Numerous molecular approaches have been described to identify genome-wide copy number changes and LOH within human biological samples. Classical LOH studies designed to identify allelic loss using paired tumor and blood samples have made use of restriction fragment length polymorphisms (RFLP) and, more often, highly polymorphic microsatellite markers (STRS, VNTRs). The demonstration of Knudson's two-hit tumorigenesis model using LOH analysis of the retinoblastoma gene, Rb1, showed that the mutant allele copy number can vary from one to three copies as the result of biologically distinct second-hit mechanisms (Cavenee, et al. (1983), Nature, Vol. 305, pp. 779-84.). Thus regions undergoing LOH do not necessarily contain DNA copy number changes. On the other hand, approaches to measure genome wide increases or decreases in DNA copy number include comparative genomic hybridization (CGH) (Kallioniemi, et al. (1992), Science, Vol. 258, pp. 818-21.), spectral karyotyping (SKY) (Schrock, et al. (1996), Science, Vol. 273, pp. 494-7.), fluorescence in situ hybridization (FISH) (Pinkel et al. (1988), Proc Natl Acad Sci USA, Vol. 85, pp. 9138-42), molecular subtraction such as RDA (Lisitsyn et al. (1995), Proc Natl Acad Sci USA, Vol. 92, pp. 151-5.; Lucito et al. (1998), Proc Natl Acad Sci USA, Vol. 95, pp. 4487-92), and digital karyotyping (Wang, et al.(2002), Proc Natl Acad Sci USA, Vol. 99, pp. 16156-61.). CGH, perhaps the most widely used and powerful approach, uses a mixture of DNA from normal and experiment cells that has been differentially labeled with fluorescent dyes. Target DNA is competitively hybridized to metaphase chromosomes or, in array CGH (aCGH), to cDNA clones (Pollack et al. (2002), Proc Natl Acad Sci USA, Vol. 99, pp. 12963-8) or bacterial artificial chromosomes (BACs) and P1 artificial chromosomes (PACs) (Snijders et al. (2001), Nat Genet, Vol. 29, pp. 263-4, Pinkel,et al. (1998), Nat Genet, Vol. 20, pp. 207-11). Hybridization to metaphase chromosomes, however, limits the resolution to 10-20 Mb, precluding the detection of small gains and losses. Currently, the availability of BAC clones spanning the genome limits the resolution of CGH to 1-2 Mb, but the recent use of oligonucleotides improves resolution to 5-10 Kb (Lucitoet al. (2003), Genome Res, Vol., pp. ). CGH and aCGH, however, are not well-suited to identify regions of the genome which have undergone LOH such that a single allele is present but there is no reduction in copy number. SNP arrays allow detecting allele-specific copy number changes and LOH regions.

One of the continuing challenges to detecting chromosomal aberrations using both array CGH and SNP arrays is data analysis and data interpretation necessary for use of both techniques in clinical diagnostics of a wide range of human disorders. Use of both technologies in a clinical setting has been somewhat restricted up to now due to difficulties in streamlining data interpretation.

### BRIEF DESCRIPTION OF THE DRAWINGS

FIG. 1 demonstrates a log-ratio plot for a human chromosome with a chromosomal aberration highlighted with a horizontal bar, location of which can be modified by user or it can be deleted.

FIG. 2 demonstrates visualization of intervals discovered in previously conducted studies indicated at the top of the plot and aligned with log-ratio data from a newly acquired sample.

FIG. 3 demonstrates an aberration frequency plot (bottom half) aligned along a log-ratio plot for a newly acquired sample (top half).

FIG. 4 demonstrates a report table with reported aberration regions grouped into folders assigned to individual chromosomes.

FIG. 5 shows parameters of an aberration region that user can edit through a log-ratio plot or a report table.

FIG. 6 shows visualization of array measurements for 2 different samples aligned together along a chromosome.

FIG. 7 shows an example of a gene significance table.

FIG. 8 shows an example of an aberration frequency profile built based on multiple samples.

### INVENTION DISCLOSURE

The current invention provides methods, systems and computer software products suitable for analyzing data from array CGH and SNP array platforms to detect changes in DNA copy number, to detect loss of heterozygosity and to present and report the results in a manner suitable for clinical diagnostics of human patients.

### A. Definitions

Nucleic acids according to the present invention may include any polymer or oligomer of pyrimidine and purine bases, preferably cytosine, thymine, and uracil, and adenine and guanine, respectively. (See Albert L. Lehninger, Principles of Biochemistry, at 793-800 (Worth Pub. 1982) which is herein incorporated in its entirety for all purposes). The polymers or oligomers may be heterogeneous or homogeneous in composition, and may be isolated from naturally occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An oligonucleotide or polynucleotide is a nucleic acid ranging from at least 2, preferably at least 8, 15 or 20 nucleotides in length, but may be up to 50, 100, 1000, or 5000 nucleotides long or a compound that specifically hybridizes to a polynucleotide. Polynucleotides of the present invention include sequences of deoxyribonucleic acid (DNA) or ribonucleic acid (RNA) or mimetics thereof which may be isolated from natural sources, recombinantly produced or artificially synthesized.

“Genome” designates or denotes the complete, single-copy set of genetic instructions for an organism as coded into the DNA of the organism. A genome may be multi-chromosomal such that the DNA is cellularly distributed among a plurality of individual chromosomes. In human there are 22 pairs of chromosomes plus a gender associated XX or XY pair.

The term “chromosome” refers to the heredity-bearing gene carrier of a living cell which is derived from chromatin and which comprises DNA and protein components (especially histones). The conventional internationally recognized individual human genome chromosome numbering system is employed herein. The size of an individual chromosome can vary from one type to another with a given multi-chromosomal genome and from one genome to another. In the case of the human genome, the entire DNA mass of a given chromosome is usually greater than about 100,000,000 base pairs (bp).

A “chromosomal region” is a portion of a chromosome. The actual physical size or extent of any individual chromosomal region can vary greatly. The term “region” is not necessarily definitive of a particular one or more genes because a region need not take into specific account the particular coding segments (exons) of an individual gene.

An “array” comprises a support, preferably solid, with nucleic acid probes attached to the support. Preferred arrays typically comprise a plurality of different nucleic acid probes that are coupled to a surface of a substrate in different, known locations. These arrays, also described as “microarrays” or colloquially “chips” have been generally described in, for example, U.S. Pat. Nos. 5,143,854, 5,445,934, 5,744,305, 5,677,195, 5,800,992, 6,040,193, 5,424,186 and Fodor et al., Science, 251:767-777 (1991).

Arrays may generally be produced using a variety of techniques, such as mechanical synthesis methods or light directed synthesis methods that incorporate a combination of photolithographic methods and solid phase synthesis methods. Techniques for the synthesis of these arrays using mechanical synthesis methods are described in, e.g., U.S. Pat. Nos. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992)

Arrays may be packaged in such a manner as to allow for diagnostic use or can be an all-inclusive device; e.g., U.S. Pat. Nos. 5,856,174 and 5,922,591. Examples of currently available commercial array platforms under the scope of the current invention are: Affymetrix, Agilent, BlueGnome, Combimatrix, Illumina, Roche Nimblegen, Oxford Gene Technology, PerkinElmer, Signature Genomics. However, this invention can be used with any array CGH or SNP array platform without limitation to the particular commercial platforms mentioned above.

An allele refers to one specific form of a genetic sequence (such as a gene) within a cell, an individual or within a population, the specific form differing from other forms of the same gene in the sequence of at least one, and frequently more than one, variant sites within the sequence of the gene. The sequences at these variant sites that differ between different alleles are termed “variances”, “polymorphisms”, or “mutations”. At each autosomal specific chromosomal location or “locus” an individual possesses two alleles, one inherited from one parent and one from the other parent, for example one from the mother and one from the father. An individual is “heterozygous” at a locus if it has two different alleles at that locus. An individual is “homozygous” at a locus if it has two identical alleles at that locus.

Normal cells that are heterozygous at one or more loci may give rise to tumor cells that are homozygous at those loci. This loss of heterozygosity may result from structural deletion of normal genes or loss of the chromosome carrying the normal gene, mitotic recombination between normal and mutant genes, followed by formation of daughter cells homozygous for deleted or inactivated (mutant) genes; or loss of the chromosome with the normal gene and duplication of the chromosome with the deleted or inactivated (mutant) gene.

A homozygous deletion is a deletion of both copies of a gene or of a genomic region. Diploid organisms generally have two copies of each autosomal chromosome and therefore have two copies of any selected genomic region. If both copies of a genomic region are absent the cell or sample has a homozygous deletion of that region. Similarly, a hemizygous deletion is a deletion of one copy of a gene or of a genomic region.

Copy number gain refers to an event of having an extra copy or copies of a gene or a genomic region compared to a normal state of an organism.

Copy number loss refers a deletion of a copy or copies of a gene or a genomic region compared to a normal state of an organism.

An aberration refers to a region of copy number gain or loss or to a region of LOH.

An aneuploid is a cell whose chromosomal constitution has changed from the true diploid, for example, extra copies of a chromosome or chromosomal region.

Arrays can be used for “detection of LOH” and/or “detection of copy number gains and losses”. In general such arrays compare the intensity of hybridization of nucleic acids to array's clones or probes and correlate higher intensity with higher copy number. The relationship between log intensity and log copy number was found to be approximately linear and using control samples of known copy number (normal samples) can provide estimates of copy number values along genome in a form of a log-ratio value. Log-ratio values can be allele-specific reflecting allele-specific DNA copy numbers. Or a single log-ratio value of hybridization intensities can be estimated for both alleles to evaluate simultaneous copy number changes in both alleles. Such log-ratio (or LogR) values, their combinations and other measurements that may correlate to copy number values and that are extracted from SNP arrays or array CGH when screening a human biological sample may serve as an input to systems and methods covered by this invention. Such data may be referred to as “array data”, “array measurements” or simply “measurements” further in this description. An example of such measurements is a set of normalized log-ratio measurements for BAC or oligonucleotide aCGH platforms (Agilent, PerkinElmer, Nimblegen etc). For SNP array platforms such measurements are represented by LogR measurements (Illumina or Affymetrix platform).

For some array platforms each probe on array provides a single measurement (log-ratio of intensities or LogR measurement). Alternatively, for other array platforms each probe can provide two different measurements. There are two possible scenarios for the latter case:
each probe provides a log-ratio type of measurement to capture simultaneous copy number changes of both alleles and an allele-sensitive measurement like an allele frequency (Illumina platform) or allelic difference (Affymetrix platform) or
each probe provides two log-ratio types of measurements, each of which is specific to one of the two alleles

Term “probe” refers to both nucleic acid probes and BACs.

Term “phenotypic attribute” refers to any kind of observable characteristic or trait of an organism: such as its morphology, development, biochemical or physiological properties, or behavior.

Term “demographic attribute” refers to any kind of population-related characteristic of an organism: such as gender, geographic origin, age etc.

### B. Data Selection and Input

One important aspect of the software system described in this invention is enabling navigation of a file system or a database system from a computer and selection of array data for one or more human samples for analysis. Each human sample may require measurements acquired from one or more arrays for proper analysis. Measurements from one or more human samples may be loaded into the system in a single software session. Probe-wise measurements from a single array may be stored in the file system in a form of computer files of various formats (defined by the array platform used) or in a database in a form of a set of database elements. Such database can reside either on the user's computer or remotely on a server either inside user's institution or outside user's institution. In case of remote location of array data transfer of array measurements to the user's computer for analysis will be performed via intranet or the Internet.

The software system would also have access to mapping from individual array measurements to probe IDs or names and to probe chromosomal positions that are necessary to align acquired array measurements along chromosomes for each individual human sample.

The system facilitates selection of array data from one or more human samples not necessarily produced by the same array platform. Array data selection can be performed by selecting particular arrays of interest or in a form of a selection of certain locations on a storage media (for example, a set of specific file directories), from which all available array data or a pre-filtered set of array data should be loaded automatically. In the latter case the described system detects all available array data at the specified locations using a priori knowledge about the format in which array data are stored and configures access to the array data for further analysis.

Selection of a particular set of human samples (arrays) can be performed based on a specific attribute value or a set of attribute values. Such attributes can be, but are not limited to biological condition of a patient (disorder, disorder type or normal sample), gender of a patient, range of dates when a patient was screened, name of laboratory or organization where a patient was screened etc. In case when such data selection method is chosen by the user, the system will automatically find all samples and the corresponding sets of array measurements that have the specified attribute values.

### C. Array Data Management and Data Set Visualization

The system shows all samples in the set of samples specified by the user using such information as file names, sample names, sample IDs and other sample attributes. After the sample set has been formed, the user may remove any of the samples from the set and/or add additional samples in the manner similar to the one described in section (B).

The system also facilitates automated grouping of loaded samples into sub-groups according to various attributes (such as, but not limited to experimental factors: gender, age, disorder type, disorder grade, name of testing laboratory etc) that have been pre-assigned to the samples. The user is able to further sub-select a group of samples from the loaded dataset and to assign a value of a specific attribute (usually, but not limited to a value of a biological factor, for instance: “female” or “healthy” or “tumor type 1” or “developmental disorder 1” or “age 30-35”) that is common for sub-selected samples. Loaded samples can be grouped into one or more groups with groups created according to similarity of their categorical values of one or more experimental factors. Sample grouping can be saved in a form of a separate file or table containing sample names/IDs mapped to values of created experimental factors. Experimental factors and factor values are also shown as a separate table that the user can use to quickly sub-select specific samples united by certain factor values.

The system has a capability of executing Copy Number and/or LOH detection algorithm or algorithms on all samples or on a selected sub-set of samples in the dataset. A variety of algorithms can be used by the system for automated Copy Number and/or LOH detection. Detection step for each sample produces a set of regions with DNA Copy Number value different from that of a normal sample and/or a set of LOH regions. Detected regions are provided by the system in terms of corresponding abnormal copy numbers and region boundaries in base pairs (or Kbp or Mbp).

After every sample in the data set has been analyzed, the system would also indicate quality of each sample in a numeric or in a graphical form in a dedicated field of the sample table. It may also indicate those samples that failed quality control during processing. This can be done by thresholding a quality metric or metrics evaluated during the analysis step. The system would also indicate the number and location of regions of Copy Number change and/or LOH for each sample from the sample set. This representation of detected regions can be performed in a text or in a graphic form in a specific field of the sample set visualization panel.

The system provides tools for sub-selecting a single sample or a set of samples for:
visualization of array measurements,
visualization of detected Copy Number and/or LOH regions,
detection or re-detection of Copy Number changes and/or LOH,
assignment of an experimental factor value,
further analysis of samples as a group,
reporting of detected Copy Number changes and/or LOH regions in a clinically meaningful document.

### D. Visualization of Array Data for an Individual Sample

Proposed system also facilitates visualization of array data for a selected human sample. After a sample is selected for visualization, the system produces at least one or any combination of the following visualization elements: a probe-wise plot of array measurements and a report table of discovered aberrations.

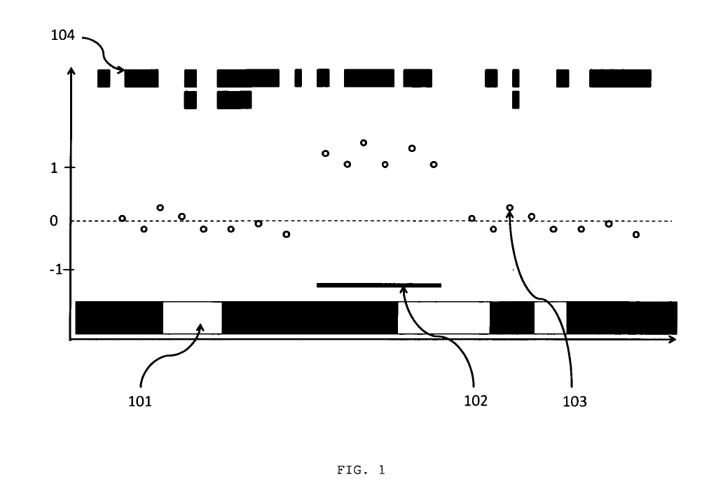

Probe-wise plot visualizes array measurements (usually log-ratios or ratios and/or allele-sensitive measurements) aligned along whole genome and/or individual chromosome or chromosomes using chromosomal positions of the probes. Such visualization can be positioned horizontally (with chromosomal positions on horizontal axis (X axis) and array measurements on vertical axis (Y axis) or vertically (with chromosomal positions on Y axis and array measurements on X axis). Chromosomal diagrams may be shown on the background of such visualizations, where chromosomal diagrams will be drawn and aligned with the axis of chromosomal positions using mapping of cytogenetic bands to chromosomal positions in terms of base pairs. Automatically detected aberration regions will be highlighted on the plot with colors providing differentiation between gain regions, loss regions and LOH regions. Such regions may be highlighted through coloring of probe-wise data points that belong to the aberration regions and/or through direct visualization of the regions as colored intervals along the axis indicating chromosomal positions. Please see FIG. 1 for an example of such a plot. FIG. 1 schematically demonstrates a plot, where probe-wise log-ratio measurements 103 are shown. A chromosomal aberration 102 is marked right above chromosomal diagram 101. Genes corresponding to the chromosomal region of the plot are shown at the top of the plot with black bars 104. Sometimes a “compressed” version of the plot can be used, where only detected aberration regions are displayed and actual probe-wise array measurements are not drawn for memory and space saving purposes.

The plot may display one type or several types of probe-wise array measurements at the same time either on the same graph or as separate graphs aligned along the axis indicating chromosome positions. Such combinations of measurements can consist of but are not limited to probe-wise log-ratios and/or allelic differences and/or allele frequencies.

The plot may also visualize known genes along the axis indicating chromosomal positions (see FIG. 1). Gene visualizations would indicate such information as gene locations and size, gene names according to selected nomenclatures, association of genes with known disorders, molecular functions, cellular components and biological processes. That information for every individual gene may be presented in a text form or in a form of a color or shape code.

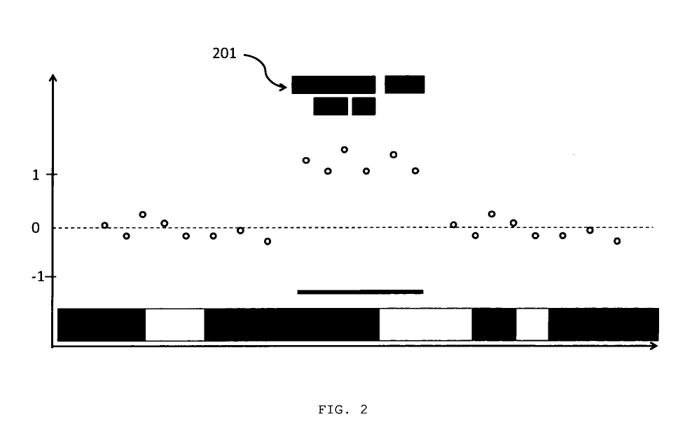

Additionally, aberration regions previously discovered in samples that are not part of the loaded dataset may be presented for reference in a form of possibly colored intervals along the axis indicating chromosomal positions. The source of such regions may be publicly available databases, publications or results of previously conducted Copy Number and/or LOH analysis conducted by the user's institution or other institutions. FIG. 2 schematically shows how aberration regions 201 detected in previous studies can be displayed on a log-ratio plot. Such visualizations would indicate such information as region's location and width, number of samples that demonstrated an aberration in that region, types of demonstrated aberrations, names and/or IDs for such samples, name and/or ID of the study, time of the study, names of investigators that performed the study, disorder that may be caused by an individual aberration and other relevant information.

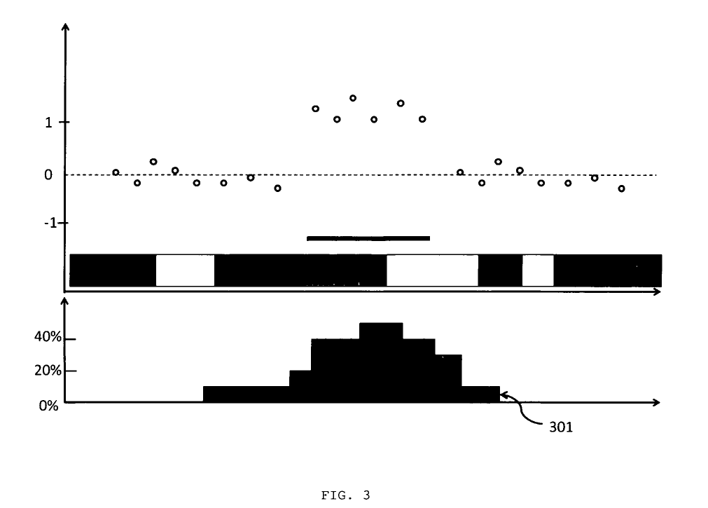

Additionally, frequency of aberrations detected for a particular group of samples (not necessarily samples from the loaded dataset) may be plotted for reference along the axis indicating chromosomal positions. Such a frequency plot, if present, will be aligned with the probe-wise array measurements plot discussed above. Please see FIG. 3 for a sample picture of such a plot. Aberration frequency 301 computed based on a set of previously analyzed samples is aligned with log-ratio data from a particular sample. The frequency plot would indicate how frequently each chromosomal position was a part of an aberration in the group of samples selected for plotting frequencies. Selection of pre-computed aberration frequency profiles for different previously analyzed sets of samples may be available for reference when working with an individual sample. The frequency plot may show frequency of just one type of aberrations (gains, losses or LOH) or frequencies for multiple types of aberrations at the same time, where frequency curves for different aberration types are marked with different colors. Such aberration frequency profile may be also computed automatically on a selected group of samples upon a user's request. For more description of aberration frequency curves please see a corresponding section further in the text (section (G)).

All types of data plotted on the probe-wise plot will be automatically properly aligned along the axis indicating chromosome positions during initial drawing and during zoom-in and zoom-out procedures executed by the user.

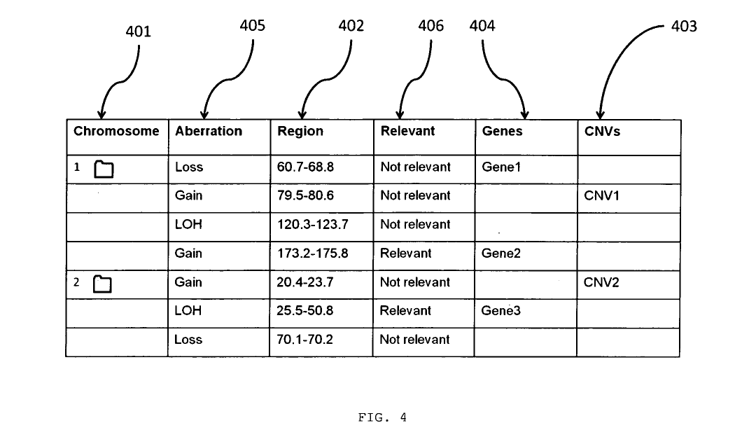

Report table of discovered aberrations is organized as a two-level tree structure with aberration regions organized into folders dedicated to different chromosomes. Please see FIG. 4 for an example of such a table. Folders in column 401 on FIG. 4 shows how all aberrations in column 405 can be grouped according to chromosome they belong to. Column 402 identifies chromosomal coordinates of all aberrations discovered for a particular chromosome. Column 406 contains user added and user editable comment about aberration's clinical relevancy. Further annotation columns like genes 404 or CNVs 403 can be added to the table and filled out automatically according to aberration's location. Either all automatically detected aberrations can be added to the report or the user can approve a sub-set of automatically detected aberrations for reporting. Each individual aberration may have multiple fields in its dedicated row of the table: aberration type, aberration boundaries, aberration width, number of copies, ISCN record, user comments, sample name(s), clinical relevance, genes within the region, disorders and other biological information associated with the genes within the region, CNVs (copy number variants) found by other studies that fell within the region etc.

Each aberration in the report can be removed or edited. User can edit information in some or all of the aforementioned fields. Report can be saved in a form of a table file (representing structure of the report table) and/or in a form of a clinical report document with text and/or graphic information about discovered aberrations and their locations.

Table of probe-wise array measurements can be also available for the user. Each row of the table represents an individual probe. The table at a minimum contains the following columns: probe names/IDs, chromosome numbers/IDs, chromosomal positions, probe-wise measurements and aberration information (normal/gain/loss/LOH).

Quality control table may have control metrics to characterize quality of the biological sample and array data under scope. Such quality metrics may include, but are not limited to standard deviation values of log-ratio measurements for the probes from individual chromosomes, standard deviation of log-ratio measurements for the probes from autosomal regions of the genome, standard deviation of log-ratio measurements for the probes from normal (non-aberrated) regions along genome, ratios of an average log-ratio value for an individual chromosome (for example, X chromosome) and one of the aforementioned standard deviations, number of probes and probe replicates detected as outliers and omitted from analysis due to certain quality control procedures at the probe level.

View of array image(s) provides user with access to visual inspection of individual spots on the array representing individual probes.

User can interact with information for individual probes (and their replicates, if present) across all interface elements mentioned in this section by selecting a probe in a particular interface element that would trigger corresponding selection and highlight of information related to that probe in other interface elements discussed above in this section. User can also select individual aberration regions in the aberration report table, which would trigger highlighting of that region on the log-ratio plot. And selection of an aberration region on the log-ratio plot would trigger highlighting of the same region in the aberration report table.

### E. Aberration Reporting Procedure for an Individual Sample

As mentioned above, the system assists user in reporting aberration regions by highlighting automatically detected aberrations with various colors and shapes depending on the type of an aberration. However, the user is also provided with utilities that allow her or him to select and remove detected aberrations that after visual inspection seem to be unrelated to the study or falsely detected regions. This can be done in the probe-wise array measurement plot and/or in the report table.

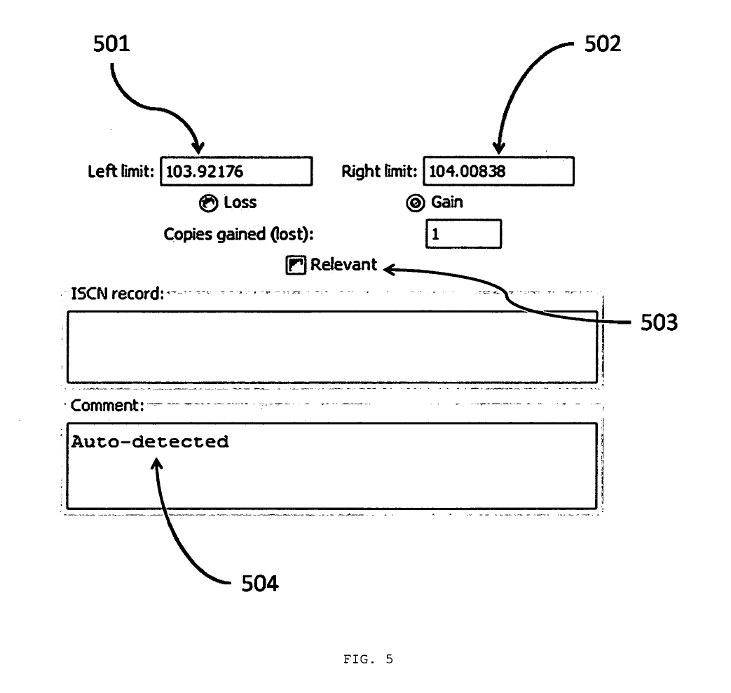

The user can also edit information for each individual aberration in the report. FIG. 5 demonstrates an example of an interface executable by the user either from the log-ratio plot or from the report table, which allows the user to change aberration boundaries 501 and 502, modify indicator of clinical relevancy of the aberration 503 and add or modify a free-text comment about the aberration 504. This allows editing of all information fields associated to an aberration in the report table (please see description of such fields in the previous section).

The user is also provided with an integrated tool for manually adding aberration regions to the report. This can be done either by entering region boundaries and other necessary information in dedicated fields manually or by interactively clicking on region's boundaries in the log-ratio plot and then associating further information with the region using provided fields. During this process the software assists the user by performing one or several of the following functions: automatically generating ISCN records, computing number of copies gained or lost, adding names for known genes covering the region, adding biological information associated with the said genes (such as disorders, biological processes, molecular functions, cellular components etc) and adding description of CNV regions discovered in other samples by previous studies.

After the user manually edits, deletes or adds aberration regions, both the report table and the array measurement plot get updated automatically to reflect changes made to the set of reported aberrations by the user. The system may use textual comments and/or different colors and shapes to differentiate between different groups of aberration regions: automatically detected (but not manually confirmed), manually reported (but not automatically detected) and manually confirmed automatically detected.

When the user is ready to finalize the report, the report can be saved in various types of formats including, but not limited to
a table file resembling the report table in its column and row structure and
a document containing textual information from the report table and maybe graphical representation of chromosomal diagrams, array measurement plots (for example, log-ratio plots) and reported aberrations along them. The software may also allow the user to add custom graphics to specific pages of the saved report file (for instance, institution logo), custom page headers, custom page footers, text that is permanent and would be added to every report (usually such text is specific to laboratory's workflow and procedures like a disclaimer or test protocol, for instance) and text that is specific to the particular sample under scope and is entered by the user during reporting session. The document will also automatically indicate sample attributes and their values assigned to the reported sample in the system along with analysis settings used to analyze array measurement.

The report can be also saved in a re-loadable format to facilitate superposition of the reported aberration regions on log-ratio plots for the current and other samples during later analysis sessions for comparison. This procedure would also facilitate addition of aberration regions detected in other human samples to the original report during later analysis sessions. Such re-loadable file format would facilitate iterative build-up of reported aberration regions in a single report using multiple samples, which in turn can be visualized and used for reference during analysis of a newly acquired human sample.

### F. Visualization of Array Data for Multiple Samples on Separate Plots

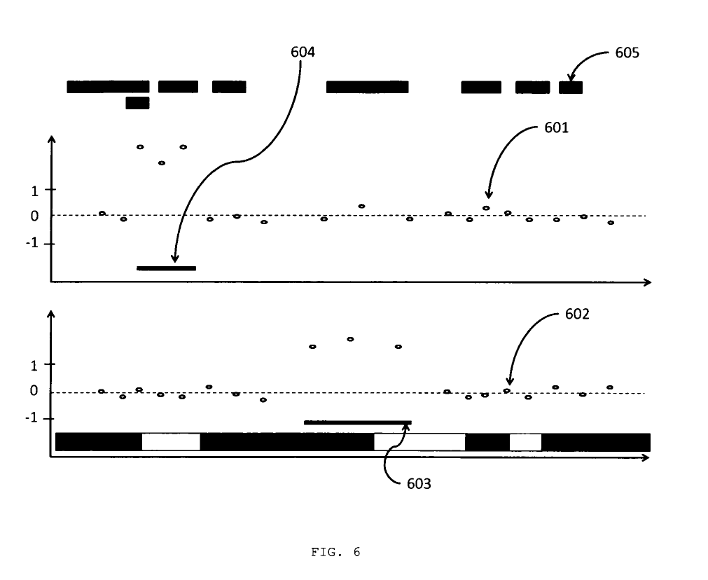

Another important aspect of the system is its ability to visualize log-ratio plots (and plots for other probe-wise array measurements) for multiple samples simultaneously as separate graphs aligned along the axis indicating chromosome positions of the probes. FIG. 6 schematically shows probe-wise log-ratio measurements for two samples 601 and 602 aligned over a region of a chromosome. There are two aberration regions 603 and 604 marked on FIG. 6: one detected and marked for sample 601 and the other one for sample 602. Corresponding gene locations are also shown on FIG. 6 as black bars 605 at the top of the plot. Such a multi-sample plot may be also shown by plotting a “compressed” plot that would display only detected aberration regions. This way the user can compare array measurements and aberration regions for multiple samples side-by-side and report aberration regions based on information from multiple samples. One important application of such multi-sample visualization is working with a group of samples acquired from members of the same family. This helps identify inherited aberrations vs. de novo aberrations, and that information can be very important when identifying clinical relevance of an aberration. Another application of this view is identification and omission of aberrations detections that are results of alterations demonstrated by samples used as a “reference” in the experiment.

Individual log-ratio plots were defined in section (D). However, in this case plots for a set of selected samples will be shown and aligned along the axis indicating chromosome positions. Alignment will be preserved during zoom-in and zoom-out operations. Reporting procedure will be similar to that of section (E), but the user will be able to approve detected aberrations or add manually reported aberrations based on available plots for all visualized samples and all reported aberrations will be presented in a single report or in separate reports dedicated to individual samples.

### G. Computation and Visualization of Aberration Information for Multiple Samples as an Aberration Frequency Diagram in a Single Plot

Proposed software system allows the user to sub-select a set of samples from the loaded dataset and to visualize information regarding detected aberration intervals for those samples as an aberration frequency diagram.

In order to build an aberration frequency diagram the system first constructs a grid of chromosome positions along genome. This grid can be either a pre-determined system of locations in terms of base pairs distributed along chromosomes (for example, an approximately uniformly distributed set of chromosome positions on each chromosome) or it can be built as a set of positions around points of detected or reported copy number changes (points where the number of DNA copies changes along a chromosome) and/or around boundaries of detected or reported LOH regions collected across all selected samples.

The number of selected samples can range from one to the total number of samples loaded into the software within the dataset.

The system calculates a percentage of samples that demonstrated an aberration for every location of the constructed grid. We will call the set of such values collected from the points of the grid “aberration frequency data”. Such data can be presented as a single value for each point of the grid demonstrating frequency of occurrence of an aberration across samples for that point, taking a user-defined combination of considered aberration types into account: copy number gain, copy number loss, allele-specific copy number changes, and/or LOH. Or aberration frequency data can have multiple values for each grid point, each value representing frequency of occurrence for a specific aberration type, with the set of aberration types of interest being pre-selected by the user.

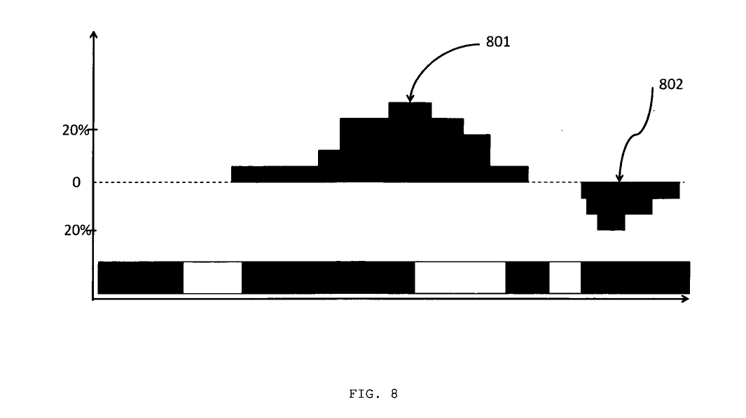

After the aberration frequency values are computed for every grid point, the system prepares a plot based on computed values, where Y axis demonstrates aberration frequency values for every grid point and X axis indicates its positions along genome with chromosomes ordered as 1, 2, . . . , 22, X, Y and with grid points inside every individual chromosome ordered according to chromosome position in base pairs. Views for an individual chromosome are also available and then only chromosome positions for that particular chromosome are used for plotting. Such plot can have chromosomal diagram(s), gene visualization, CNV visualization etc applied to it in a manner similar to that described in the section regarding the probe-wise array measurement plot (section (D) above). Frequency values for different types of aberrations, if available, can be plotted on the same plot using different colors and/or shapes. Data points of the plot can be connected sequentially according to their chromosome position with lines to form a histogram-like figure. Such connection is performed individually for aberration frequency values of each aberration type. Area between the line connecting aberration frequency data points and the line Y=0 may be filled with a color corresponding to the color of the data points. Such plot can be positioned so that axis X is drawn horizontally or so that axis X is drawn vertically. In case of plotting separate aberration frequencies for gains and losses the software may align both plots along X axis, but direct the plot for the gains upward from X (Y axis with percentage values directed up) and the plot for the losses downward from X (Y axis with percentages directed down). Please see FIG. 8 for an example. Frequencies for detected gains are shown pointing up (801) and frequencies for detected losses are shown pointing down (802).

The system will also highlight parts of the plot that indicate regions with aberration frequency values higher than a certain percentage threshold pre-selected by the user. Such parts of the plot may be indicated by dedicated colors.

The user may interact with the histogram plot by putting mouse cursor over a specific data point or a region between data points and/or clicking a mouse button, as a result of which the system will provide the user with the following information for the grid points in the neighborhood of the mouse cursor: particular aberration frequency value(s), chromosome position, probe IDs around chromosome position, names/IDs of samples that demonstrated aberrations around that chromosome position, genes at the chromosome position, associated biological information for the genes, CNVs from previously conducted studies at that chromosome position etc. The user can also select from the list of samples that demonstrated an aberration at the selected chromosome position and view a probe-wise array measurement plot for that particular sample aligned with the aberration frequency diagram along X axis. Executed probe-wise array measurement plot would have full or restricted functionality of the array measurement plot described in sections (D), (E).

Such aberration frequency data can be saved by the user into a file either in a table format or in a re-loadable binary format. Such data can be loaded back into the software at any point and visualized either as a stand-alone frequency plot or as a frequency plot aligned with another plot (for instance, for comparison with a probe-wise array measurements plot for a specific sample or with another aberration frequency plot).

H. Reporting of Aberration Regions using the Aberration Frequency Diagram

The user can choose a threshold in terms of a fixed value of aberration frequency (ranging from 0% to 100% if entered as a percentage or from 0.0 to 1.0 if entered as a fraction value) that would indicate what percentage of samples needs to demonstrate an aberration in each region in order for it to get reported. According to the value of the threshold (denoted further by T), the system would draw a line Y=T on all available aberration frequency plots and report all intervals along X axis within which all available grid points demonstrated aberration frequency higher or equal to T. Such intervals will be defined by their boundaries in terms of chromosome positions and will be added to the report table part of the software interface defined earlier.

All regions reported using this method will have at least the following fields in the report table: region boundaries, minimum aberration frequency inside the region, maximum aberration frequency inside the region, average aberration frequency inside the region, width of the region, genes from the region, biological information associated with the genes in the region (such as disorders, biological processes, molecular functions, cellular components etc), CNVs from the region discovered in earlier studies, other chromosomal regions of interest provided by the user to the software prior to analysis belonging to the reported region and the list of samples (names and/or IDs) that demonstrated the reported type of aberration in the region.

General structure of the report table and operations that the user can conduct on it are similar to those described in sections (D), (E).

### I. Visualization of Aberration Information for Multiple Groups of Samples as Multiple Aberration Frequency Plots

The user can select multiple sub-groups of samples from the loaded dataset and construct aberration frequency data for each of the sub-groups. Then such data can be visualized as a set of aberration frequency diagrams from section (G) aligned together along axis X (axis indicating chromosome positions). Aberration frequency diagrams for different sample sub-groups can also be plotted on the same graph with different colors and/or shapes indicating plots for different sub-groups of samples. Such visualization can be used to compare aberration profiles across different groups of samples, within each group samples are collected according to a common attribute (for example, biological condition). Reporting of aberration regions can be performed on any plot from the set similarly to how it was described in section (H).

### J. Visualization and Construction of Custom Tracks

The user can choose to visualize a pre-built custom track on a probe-wise array measurements plot and/or an aberration frequency plot. This helps the user to compare aberration regions detected in one or more samples from the currently loaded dataset to the aberration regions reported in previous studies or simply with a pre-compiled set of regions of interest. Regions from such a track will be visualized as intervals along the axis indicating chromosome positions on the plot. The user can visualize multiple tracks on the same plot using different colors (each track with s specific color). The user can use mouse cursor to access information about individual regions from a custom track such as track name/ID, region name/ID, region width, region boundaries, types of aberrations occurred in the region etc. The system will store individual custom tracks in dedicated files or in a database and retrieve them for visualization if requested by the user.

The user will be able to interact with custom tracks and add, edit and/or remove individual regions in the custom track. When adding a region to the track the user would be able to add detected or reported aberration regions from existing report table for the loaded set of samples. When editing a region, the user would be able to edit region boundaries, region name/ID, list of names/IDs for the samples that showed an aberration in the region. Editing can be done by clicking on a particular region and filling provided fields with necessary information. If the user alters a custom track in any way, this information gets updated to the source of the custom track—file or database so that updated track can be used in the current and following software sessions.

Initial custom track can be created by compiling information about individual regions (boundaries and other information) for the track using other software packages like table editing packages and saving that information in a file format that the system can read from and write to. Also a system's re-loadable report file (described in section (D)) saved by the user during one of the analysis sessions can be used as a source of custom track information.

As an alternative, such custom track can be visualized as an aberration frequency plot aligned with the currently viewed plot. In that case the user can either load a previously saved file with aberration frequency data for a particular dataset or build such an aberration frequency profile by selecting a set of samples and requesting to build an aberration frequency profile based on them. Please see section (G) for detail.

Selection of samples for building a custom track can be based on manual selection from samples available in the system or on automated selection using a certain sample attribute like a certain disorder samples were diagnosed with, name or type of laboratory that performed analysis on samples etc.

K. Restricting Detection of Copy Number Changes and/or LOH to the Regions of Interest

User may provide a list of regions of interest to the software in a form of a delimited text table file or any other format containing region location and boundaries and other associated information like clinical relevance of the region, institution or lab that discovered the region etc. If such a list is made available by the user, the software will only highlight and report those detected regions of Copy Number change and/or LOH that overlap with one or more regions of interest.

User may also provide a list of genes of interest in terms of gene names listed in a file or in a database table. If such a list is made available by the user, the software will only highlight and report those detected regions of Copy Number change and/or LOH that overlap with one or more genes of interest.

User may also provide regions or genes to ignore during automated aberration detection. If such an option is selected, the software will exclude from report detected aberration regions that overlap by at least a certain pre-defined percentage of their width (in terms of number of probes or base pairs) with at least one of pre-defined regions of exclusion provided by the user.

User may also provide an aberration frequency profile for a set of samples and specify a certain threshold value, instructing the software system to ignore detected aberration regions where the provided aberration frequency values are higher than the specified threshold value. Similarly, the user can instruct the software to ignore those detected regions where the provided aberration frequency values are lower than the specified threshold value.

### L. Short-Listing Significantly Affected Genes for a Particular Sample

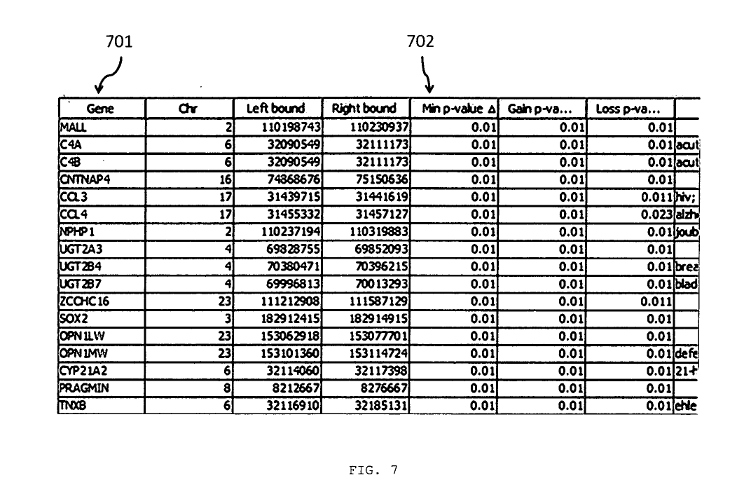

When aberrations are detected and displayed for a particular sample, the user may execute an option where the software will display a list of genes significantly affected by detected aberrations. Listed genes will represent a small sub-set of all human genes and will be sorted according to the value of significance of them being affected by the aberrations. Preferred implementation of such an option is a table listing gene names, their locations and boundaries, computed p-values representing gene significance, disorders possibly associated to the genes, gene's biological processes, molecular functions and cellular components. Please see FIG. 7 for an example. Column 701 contains gene symbols and column 702 contains corresponding significance p-values. The table is sorted according to p-values so that lowest p-values marking most significant genes are at the top. The user will be able to select a particular gene in the table and the software will automatically display array measurements plot with the gene region highlighted.

Preferred method for computing significance of the genes is computing a complement to the cumulative distribution function of a binomial distribution with 1 being the total number of trials and 0 (gene is not part of an aberration) or 1 (gene is part of an aberration) being the number of successful trials. The remaining parameter p (probability of success) of the binomial distribution is computed by calculating the frequency of the gene region being a part of the same type of an aberration in seemingly healthy patients. The set of aberration frequency values for seemingly healthy patients can be computed in accordance with section (G). Genes then can be sorted according to the computed p-value from low p-values to high. Lower p-value will denote higher gene significance.

### M. Short-Listing Significantly Affected Genes for a Set of Samples

User can assess significance of individual genes being aberrated in a set of samples loaded into the software. This is usually done after an aberration frequency profile is computed for the sample set. In this case functionality of this option is similar to the one described in section (L). The only difference is in how p-values denoting gene significance are calculated. Preferred method for computing significance of the genes combining multiple samples is computing a complement to the cumulative distribution function of a binomial distribution with the total number of samples in the dataset being the total number of trials the number of samples where the gene was a part of a particular type of an aberration being the number of successful trials. The remaining parameter p (probability of success) of the binomial distribution is computed by calculating the frequency of the gene region being a part of the same type of an aberration in seemingly healthy patients.

### N. Automated Unsupervised Construction of Aberration Frequency Profiles for Pre-Defined Types of Samples

The system can be equipped with a module for unsupervised computing of aberration frequency profiles based on grouping available samples according to the values of pre-defined attributes. The set of such attributes will be pre-defined by the user and may contain, but is not limited to disorder type or other phenotypic or biological information, patient's demographic information, parameters of the diagnostic test, results of the diagnostic test, laboratory and technician information etc.

If this option is selected by the user, the system will periodically perform aberration analysis on groups of samples defined by similarity of their attribute values and build aberration frequency profiles for the groups. Generated aberration frequency profiles in numeric or graphical forms will become available for user's analysis and reporting workflow as described in sections (D), (G), (I), (L), (M).

### O. Digital Signature of Array Data

Each analyzed sample may get assigned a digital signature in the system once analysis is executed on the sample. Digital signature will be constructed using a sub-set of array measurements using either a pre-selected sub-set of probe or clone locations on the array or a randomly distributed set of probe or clone locations on the array. Preferred implementation of such a signature will include a list of probe or clone locations or IDs on the array used to construct the digital signature and the list of corresponding array measurements (signal measurements, ratios, log-ratios and similar) at those locations. An array measurements added to the signature may be truncated to have only a restricted number of digits from the actual array measurement to reduce the size of the signature. One particular form of such a signature can be: N1:N2:N3:N4:N5:X1:X2:X3:X4:X5. N1-N5 indicate position of an individual probe or clone on the array or its order of appearance in the data file representing the array. Alternatively, N1-N5 could be clone or probe IDs used in the data file representing the sample. X1-X5 represent actual array measurements corresponding to the selected probes or clones and can be the measurements themselves or any kind of mathematical transformations of the measurements (like truncated measurements, absolute values of the measurements etc). Both N1-N5 and X1-X5 can be used in a numeric or textual form to create a signature. The number of probes or clones (5 in the example above) can vary from 1 to M, where M is less than or equal to the number of probes or clones on the array. Relative ordering of probe numbers and array measurements in the signature can be alternative to the one in the example above. Other forms of digital signatures derived from array measurements and uniquely describing data extracted from individual sample and therefore the sample itself (or identifying the sample with high probability) can be used.

Digital signatures are then stored for each analyzed sample by the system either locally or remotely and are used to identify whether the sample has been already processed by the system.

1. A method of displaying possible regions of DNA anomalies on a log-ratio plot wherein data acquired from a particular human sample with array CGH or SNP array technology is plotted for a particular human chromosome specified and changeable by the user, the method providing user interface for conducting the following operations:
a. manually adding one or more regions of possible DNA anomalies on the plot,
b. manually removing one or more regions of possible DNA anomalies from the plot and
c. manually modifying boundaries of a region of DNA anomalies displayed on the plot.

2. The method of claim 1 wherein the log-ratio plot is aligned with an image of ideogram for the corresponding human chromosome.

3. The method of claim 2 wherein the log-ratio plot is further aligned with graphical representation of gene locations for the corresponding human chromosome.

4. A software system comprising:
a log-ratio plot wherein data acquired for a particular human sample with array CGH or SNP array technology is plotted for a particular chromosome specified and changeable by the user, with one or more regions of possible DNA anomalies displayed alongside said log-ratio plot and
a table of the same set of regions of possible DNA anomalies with displayed as its rows and corresponding region's coordinates displayed as columns wherein regions are grouped according to the related chromosome number and sorted within each group according to the region's starting coordinate along chromosome,
the software system providing user interface for conducting the following operations:
a. manually adding one or more regions of possible DNA anomalies on the plot and at the same time in the table,
b. manually removing one or more regions of possible DNA anomalies from the plot and at the same time from the table
c. manually modifying boundaries of a region of DNA anomalies displayed on the plot and in the table.

5. The software system of claim 4 wherein the table of regions of possible human DNA anomalies further contains as columns one or more of the following:
a. region length,
b. number of corresponding DNA copies,
c. clinical relevance of the anomaly,
d. textual description of the region and the anomaly,
e. list of genes co-located with the region,
f. known copy number variants co-located with the region.

6. The software system of claim 4 wherein user's operations are assisted with a display of a cross-sample aberration frequency profile for one or more types of aberrations detected in a set of human samples, the software system displaying said aberration frequency profile in alignment with the log-ratio plot.

7. The software system of claim 6 wherein the frequency profile is constructed on a set of human samples, the samples being automatically selected as having a common value of at least one demographic or phenotypic attribute.

8. The software system of claim 7 wherein the frequency profile is automatically re-computed regularly or whenever a new human sample is added to the software system, the frequency profile being stored on a storage medium after computation.

9. The software system of claim 6 wherein the frequency profile is pre-computed and is loaded from a storage medium located on the same computer where the software system resides or from a remote location.

10. The software system of claim 4 wherein user's operations are assisted with a display of regions of possible DNA anomalies detected in one or more human samples other than the particular human sample used for displaying the log-ratio plot, the displayed regions being aligned with the log-ratio plot.

11. The software system of claim 5 wherein the assisting regions are grouped into more than one group and the groups can be visually distinguished from each other using shape, color, texture or text of their member regions.

12. The software system of claim 10 wherein information about the assisting regions is loaded from a storage medium located on the same computer where the software system resides or from a remote location.

13. The software system of claim 10 further including user interface for conducting the following operations:
a. manually adding one or more assisting regions,
b. manually removing one or more assisting regions and
c. manually modifying boundaries of an assisting region,

14. The software system of claim 13 further saving the modified set of assisting regions to a storage medium located on the same computer where the software system resides or to a remote location.

15. The software system of claim 4 wherein user's operations are assisted with a display of regions wherein the regions are constructed by finding intervals where aberration frequency values for a certain set of human samples were higher than a specified threshold value.

16. The software system of claim 4 wherein user's operations are assisted with a display of regions wherein the regions are constructed by finding intervals where aberration frequency values for a certain set of human samples were lower than a specified threshold value.

17. The software system of claim 4 wherein user's operations are assisted with a display of a list of genes significantly affected by DNA anomalies detected in a set of human samples other than the particular human sample used for displaying the log-ratio plot.

18. The software system of claim 17 wherein the list of genes is determined by assigning a numerical value to every gene on the human genome and selecting those genes with the numerical value being lower than a specified threshold.

19. The software system of claim 17 wherein the list of genes is determined by assigning a numerical value to every gene on the human genome and selecting those genes with the numerical value being higher than a specified threshold.

20. The software system of claim 18 wherein the numerical values are computed using cumulative distribution function of a binomial distribution.

21. The software system of claim 19 wherein the numerical values are computed using cumulative distribution function of a binomial distribution.

22. The software system of claim 4 wherein the edited list of regions of DNA anomalies can be saved to a storage medium located on the same computer where the software system resides or to a remote location.

23. The software system of claim 4 wherein user's operations are assisted with a display of additional one or more log-ratio plots wherein data acquired for one or more human samples with array CGH or SNP array technology is plotted, the assisting human samples being related to the sample displayed on the original log-ratio plot as parental samples and/or grand-parental samples.

24. The software system of claim 4 wherein a user interface is provided for manually marking some or all regions of possible DNA anomaly as clinically relevant and/or some or all regions of possible DNA anomaly as clinically irrelevant and the two different groups of regions will be clearly distinguished on both the log-ratio plot and the table using color, shape, texture or text.

25. The software system of claim 24 wherein the user-added information about clinical relevance or irrelevance of displayed regions can be further saved to a storage medium located on the same computer where the software system resides or to a remote location.

26. The software system of claim 22 wherein after the edited list of regions of DNA anomalies is saved to the storage medium, a digital signature of the original array CGH or SNP array data used to generate the list is saved to a storage medium located on the same computer where the software system resides or to a remote location, with the digital signature uniquely or with high probability identifying the data extracted by array CGH or SNP array technology from the human sample and at the same time taking less than 10% of the storage space occupied by the original array data for the sample.

27. The software system of claim 26 wherein the stored digital signatures are matched to a digital signature of array data for each processed human sample in order to determine the sample has already been processed by the software system.
